(19) United States
(12) Patent Application Publication
(10) Pub. No.: US 2011/0168604 A1
(43) Pub. Date: Jul. 14, 2011

(54) METHOD FOR CO-HYDROGENATING LIGHT AND HEAVY HYDROCARBONS

(76) Inventors: Cornelis F. van Egmond, Pasadena, TX (US); Doria Mooneyhan-Michael, Houston, TX (US); Daniel Lam, Houston, TX (US); Joel Guillaume, Houston, TX (US)

(21) Appl. No.: 12/685,889

(22) Filed: Jan. 12, 2010

(51) Int. Cl. C10G 45/00; B01J 8/00

(52) U.S. Cl. 208/57; 422/610

(57) ABSTRACT

A system and method are disclosed that allow a user to combine raw light hydrocarbons (e.g., C₄ hydrocarbons) and raw heavy hydrocarbons (e.g., gasolines and/or C₅+ hydrocarbons) streams together prior to hydrogenation. The system and method allow light and heavy hydrocarbons to be hydrogenated simultaneously within a single reactor. An system and method are also disclosed which provides specific conditions for minimizing light hydrocarbon losses during hydrocarbon processing. In particular, the disclosed method provides pressure conditions in post reactor stabilizers that facilitate venting of un-reacted hydrogen and the condensation of light hydrocarbons. Under the disclosed conditions, light hydrocarbon losses are minimized during the method and the condensed light hydrocarbons can be either recycled back into the system or utilized as a fungible energy source.

### FIELD AND BACKGROUND OF THE INVENTION

The disclosure relates to hydrogenation and co-hydrogenation of two different hydrocarbon streams. More particularly, the present invention is directed to the simultaneous hydrogenation of relatively lighter hydrocarbons (e.g., C₄ hydrocarbons) and relatively heavier hydrocarbons (e.g., gasoline) and a reduction in light hydrocarbon loss and/or improved light hydrocarbon recovery.

Hydrocarbons are feedstocks for petrochemical industries. Olefins, diolefins, and paraffins are useful for preparing a wide variety of petrochemicals, especially light hydrocarbons, such as C₄ hydrocarbons (i.e., mixtures consisting of butanes, butylenes and butadienes) and heavier hydrocarbons, such as gasolines (generally, C₆+ hydrocarbons). These petrochemicals are typically produced by cracking petroleum feeds. A large number of methods described in the literature are directed to the production of olefins, such as steam pyrolytic cracking or catalytic cracking in processes such as fluid catalytic cracking (FCC) and deep catalytic cracking (DCC). With the high cost of suitable feedstocks for producing olefins, there is an increasing demand for energy efficient and lower capital production methods. Key to project economics is also reducing the loss of valuable reaction products during subsequent purification steps.

A variety of methods are available for producing light hydrocarbon streams, such as C₄ olefinic streams (i.e., butylenes, isobutylene and butadienes), including steam cracking, fluid catalytic cracking, deep catalytic cracking, catalytic naphtha cracking and the conversion of methanol to olefins (MTO). These methods generate light hydrocarbons and heavy hydrocarbons. Additionally, the light and heavy hydrocarbons contain sulfur compounds (e.g., mercaptans, thiophenes) and polyunsaturated hydrocarbons, which need to be processed, i.e., hydrogenated, in order to make these light hydrocarbons and heavy hydrocarbons fungible, or ready for further processing to fungible products.

Current methods require the light hydrocarbons to be fractionated from the heavy hydrocarbons prior to the hydrogenation step so that each fraction can be processed separately. After the light and heavy fractions are separated, the light and heavy fraction streams are then fed into their respective reactors to undergo hydrogenation and further processed. Because the hydrogenation of the light and heavy fractions are carried out in separate streams and, thus, separate reactors, duplicate and redundant purification equipment is required to process the respective fractions.

There are several disadvantages of the hydrogenation methods currently practiced in the industry. First, because the light and heavy hydrocarbons must be separated prior to hydrogenation, additional energy intensive steps and costly purification equipment is required for carrying out the purification steps. Also, the hydrogenation of the separate light and heavy hydrocarbons are carried out in separate streams and, thus, separate reactors, duplicate and redundant purification equipment is required to method the separate fractions. Therefore, the current practiced methods require additional energy and equipment for carrying out the fractionation step and the hydrogenation steps, which is more costly than simultaneous hydrogenation.

Additionally, with the current practiced methods, portions of the light hydrocarbons and un-reacted hydrogen are typically released and/or vented together during different stages of the hydrogenation system. For example, raw gasoline will have some level of light hydrocarbons, which will be lost in the first stabilizer after the hydrogenation reaction. The light hydrocarbons that are released and lost at this stage have potential value to be used as a fungible product rather than burned as fuel. Thus, the current hydrogenation and hydrocarbon processing stages result in a loss of useful and fungible products.

Accordingly, there is a need for a system and method for processing raw light and raw heavy hydrocarbons simultaneously to circumvent the additional processing steps and process equipment that is currently necessary. There is also a need for a system and method which reduces or minimizes the loss of useful hydrocarbons that are typically lost to the fuel system as a vent product during the purification steps.

### BRIEF SUMMARY

The present invention is directed to a system and method for co-hydrogenating light hydrocarbons and heavy hydrocarbons while reducing or minimizing light hydrocarbon loss, said method comprises:
(a) obtaining a stream comprising light hydrocarbons and heavy hydrocarbons;
(b) hydrogenating the combined hydrocarbon stream in (a) a first-stage hydrogenation reactor to produce a partially hydrogenated hydrocarbon stream;
(c) condensing the partially hydrogenated hydrocarbon stream in a first-stage effluent stabilizer to produce a condensed partially hydrogenated stream and an off-gas stream;
(d) optionally directing said condensed partially hydrogenated stream to a tailing tower to separate relatively heavier hydrocarbons from relatively lighter partially hydrogenated hydrocarbons;
(e) hydrogenating said relatively lighter partially hydrogenated hydrocarbons in a second stage hydrogenation reactor to produce a fully hydrogenated hydrocarbon stream,
(f) condensing the fully hydrogenated hydrocarbon stream in a second-stage effluent stabilizer to produce a condensed fully hydrogenated hydrocarbon stream and a second off-gas stream; and
(g) directing said condensed fully hydrogenated hydrocarbon stream to a finishing tower, to separate hydrogenated light hydrocarbons from hydrogenated heavy hydrocarbon products.

The present invention also provides a system for co-hydrogenating light hydrocarbons and heavy hydrocarbons while reducing light hydrocarbon loss, said system comprises a first-stage hydrogenation reactor, a first-stage effluent stabilizer, a tailing tower, a second stage hydrogenation reactor, a second-stage effluent stabilizer and a finishing tower, wherein the light hydrocarbon stream and heavy hydrocarbon stream are combined for simultaneous hydrogenation within the first-stage hydrogenation reactor and the second-stage hydrogenation reactor.

The present invention inventively provides a system and method for hydrogenating a mixture of light and heavy hydrocarbons simultaneously, which normally are hydrogenated as separate streams. The present invention reduces the loss of light hydrocarbons (e.g., C₄ hydrocarbons) during production, so that these compounds can be further processed into a fungible product.

The disclosed system and method allow a user to combine light hydrocarbons (e.g., C₄ hydrocarbons) and heavy hydrocarbons (e.g., gasolines and C₆+ hydrocarbons) streams prior to subjecting the hydrocarbons to hydrogenation. The system and method, therefore, allow light and heavy hydrocarbons to be hydrogenated simultaneously within a single reactor, rather than in separate hydrogenation systems. Because a preliminary fractionation step and duplicative hydrogenation equipment are not required, the disclosed co-hydrogenation method reduces both energy and the amount of equipment required for hydrogenating light and heavy hydrocarbons.

The disclosed system and method also provide preferred conditions for reducing light hydrocarbon losses during production. In particular, the disclosed system and method provide preferred temperature and pressure conditions in the post-reactor stabilizers, which facilitate the venting of un-reacted hydrogen and the condensation of light hydrocarbons. Under the disclosed preferred conditions, light hydrocarbon losses are substantially reduced and the condensed light hydrocarbons can be either recycled back into the system or purified to become a fungible product. The system and method allow the post-reactor stabilizers to substantially reduce the loss of valuable product.

### BRIEF DESCRIPTION OF THE SEVERAL VIEWS OF THE DRAWINGS

FIG. 1. depicts, in flow chart form, an embodiment of the present invention.

### DETAILED DESCRIPTION OF THE INVENTION

Hydrocarbons may be acyclic, cyclic or aromatic in structure. A major source of hydrocarbons is often referred to as pyrolysis liquids. Hydrocarbons are often contained in the effluent of a hydrocarbon conversion method in which the feed hydrocarbons are cracked, either thermally or catalytically (or both), thereby forming paraffins, olefins, diolefins and a variety of aromatic compounds. After thermal or catalytic cracking, raw hydrocarbon products are formed, including raw light hydrocarbons (e.g., C₄ hydrocarbons) and raw heavy hydrocarbons (e.g., gasolines and/or C₅+ hydrocarbons). In the practice of the present invention, particularly suitable feedstocks for the hydrogenation reactor include gasoline and C₄ streams from thermal and catalytic cracking processes, distillates from cokers and coal gasification. The subject method, however, may be applied to any feed stream comprising combined light and heavy hydrocarbons.

The feedstocks useful in the practice of the present invention can comprise any hydrocarbon produced by any method. The hydrocarbons can include paraffinic, mono-olefinic and diolefinic hydrocarbons, which may be either acyclic or aromatic in structure. Specific examples include, but are not limited to, C₂ hydrocarbons including acetylene, ethene, and ethane; C₃ hydrocarbons including propane, propene, isopropene, propyne and propadiene; C₄ hydrocarbons including butane, isobutane, the butenes, butyne, cyclobutane, methylcyclopropane, butadiene; C₅ hydrocarbons including pentene, pentyne, cyclopentane, methylcyclobutane, ethylcyclopropane, pentadiene, isoprene; C₆ hydrocarbons including hexene, hexyne, cyclohexane, methylcyclopentane, ethyl cyclobutane, propylcyclopropane, hexadiene, benzene; C₇ hydrocarbons including heptene, heptyne, cycloheptane, methylcyclohexane, heptadiene, toluene; C₈ hydrocarbons including octene, octyne, cyclooctane, octadiene, styrene, xylenes; C₉ hydrocarbons including nonene, nonyne, cyclononane, nonadiene, cumene; C₁₀ hydrocarbons including decene, decyne, cyclodecane, decadiene, naphthalene.

Light hydrocarbons are typically considered to be hydrocarbons with a low molecular weight, such as C₂ to C₄ hydrocarbons. Heavy hydrocarbons are typically considered to be hydrocarbons with a higher molecular weight, such as C₅ to C₈ and higher hydrocarbons, gasolines, heavy naphthas, kerosene, diesel, gas oils as well as other refinery products.

Raw light and heavy hydrocarbons formed during the hydrocarbon conversion method include saturated and unsaturated hydrocarbons. The unsaturated hydrocarbons that are formed require additional processing to become a fungible hydrocarbons for motor gasoline blending. This processing includes a hydrogenation step to hydrogenate unsaturated raw hydrocarbons. Traditional methods require the raw feeds to be fractionated into light and heavy streams before the hydrocarbons are subjected to a hydrogenation reaction.

The present invention, however, represents a significant improvement over the prior art processes in that the present invention does not require a preliminary fractionation step that is traditionally used in the field. Instead, the disclosed system and method allow for light and heavy hydrocarbons to be combined prior to hydrogenation. Light and heavy hydrocarbons can be produced from any method, such as cracking and/or conversion. The raw product from these methods, which contain heavy and light hydrocarbons, can be utilized in the present invention without being fractionated or separated or only being subject to a rough separation before entering the system or method. Alternatively, if the light and heavy hydrocarbons have been fractionated or separated, then these fractions can be combined either prior to entering the first-stage hydrogenation reactor or upon entering the hydrogenation reactor.

The light hydrocarbons:heavy hydrocarbons mass ratio (“L:H”) of the combined hydrocarbons can be present at any mass ratio. The L:H ratio typically ranges from about 20:1 to about 1:20, preferably from about 1:10 to about 10:1; more preferably from about 1:5 to about 5:1 and any ratios in between. According to an embodiment of the invention, the L:H mass ratio is about 1:1.

The present invention provides a system and method for hydrogenating light, (i.e., C₄ hydrocarbons) and heavy hydrocarbons (i.e., C₅₊ hydrocarbons) simultaneously without requiring a fractionation step prior to hydrogenation. In particular, raw light hydrocarbons and raw heavy hydrocarbons that are already combined or are obtained as separate streams and purposefully combined and co-hydrogenated within the same hydrogenation reactor. As such, the present invention saves both energy and equipment costs, because the different hydrocarbons can be processed simultaneously within the same reactor systems.

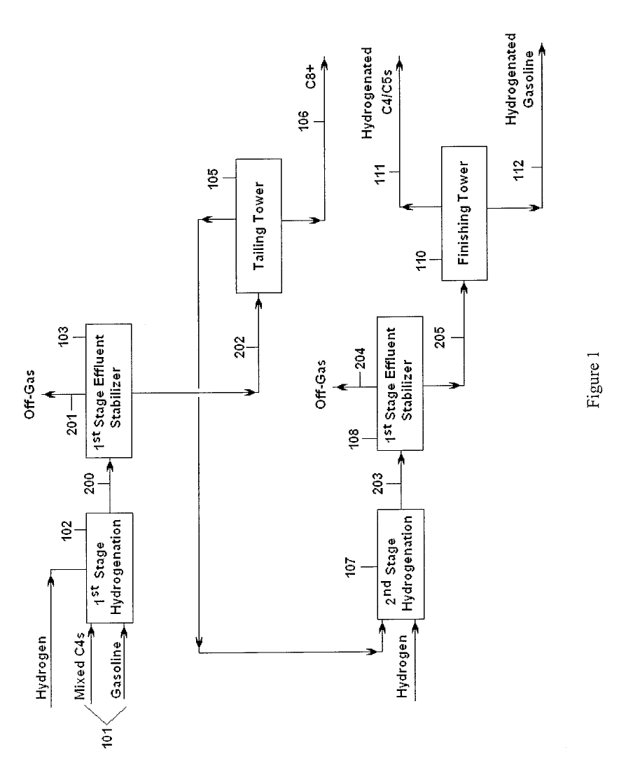

The following example is intended for illustrative purposes only and should not be considered as limiting the invention. FIG. 1 illustrates, in flowchart form, an embodiment of the disclosed system.

Unsaturated hydrocarbons enter the system of the present invention from an input source, such as a Steam Cracking Unit (SCU), as a combined light and heavy hydrocarbon mixture or as a light hydrocarbon feed and a separate heavy hydrocarbon feed. Hydrocarbon feeds entering the system and will include light hydrocarbon feeds, like raw C₄ hydrocarbons and heavy hydrocarbon feeds including pygas/gasoline (containing C₆+ hydrocarbons) feeds, light reformates, and optionally other C₅+ hydrocarbon feeds (101).

The various hydrocarbon feeds can optionally enter into a first-stage hydrogenation feed drum as liquids or gases where the feeds are combined and mixed prior to entering the first-stage hydrogenation reactor (not shown in the FIGURE). If the feeds are combined in a feed drum, the feeds exit the first-stage feed drum as a combined liquid stream. The combined liquid stream comprising various hydrocarbons then optionally passes through a first-stage hydrogenation feed pump and a hydrogenation feed filter to increase the stream pressure prior to entering the first-stage hydrogenation reactor.

Alternatively, the various feeds can directly enter the first-stage hydrogenation reactor (102) where the feeds are combined. This alternative does not require a first-stage feed drum.

The temperature in the first-stage hydrogenation reactor (102) ranges from about 100° C. to about 130° C., preferably from about 113° C. to about 120° C. The pressure in the first-stage hydrogenation reactor ranges from about 22 bag g to about 38 bar g, preferably from about 23 bar g to about 34 bar g.

First-stage hydrogenation catalyst preferably will be either a nickel, palladium, cobalt, molybdenum or chrome based catalyst or mix of these metals. Catalyst volume is a function of feed rate and diolefins and styrenics compound concentration and desired catalyst cycle life time. Within the first-stage hydrogenation reactor, a partial hydrogenation reaction occurs that focuses on the hydrogenation of butadiene and styrene components in the feed streams. The partial hydrogenation is performed under reaction conditions (e.g., temperature, pressure, volume, etc.) that vary depending on the type of catalyst used and these related reaction conditions are known to those skilled in the art. Hydrogenation of all olefinic compounds (e.g., mono-olefins) is not attempted in the first-stage reactor. Hence, the term partial hydrogenation is used to describe the function of the first-stage reactor.

After passing through the first-stage partial hydrogenation reactor (102), the partially hydrogenated stream can optionally pass through a first-stage hydrogenation recycle pump (not shown) and be sent back to the first-stage hydrogenation reactor (102) for increased conversion of diolefins and styrenics compounds. Alternatively, the hydrogenation product can be sent through a control valve (not shown) to significantly reduce the stream pressure and sent to a subsequent stabilizer tower (not shown) for further processing.

The post-first stage partially hydrogenated stream (200) is then sent to a first-stage effluent stabilizer (103) for further processing. The first-stage effluent stabilizer (103) is also known as a topping tower, a post first-stage reaction stabilizer, or a first-stage stabilizer. The post-first stage reactor hydrogenation product stream (200) that enters the first-stage effluent stabilizer (103) typically comprises partially hydrogenated C₄ to C₈ hydrocarbons along with other light and heavy hydrocarbons.

Maintaining an appropriate pressure and temperature within the first-stage effluent stabilizer (103) reduces light hydrocarbon loss from the system. Typically, if the pressure within the first-stage effluent stabilizer (103) is above 15 bar g, then additional energy is required to separate the light hydrocarbons from the un-reacted hydrogen. Alternatively, if the pressure in the first-stage effluent stabilizer (103) is too low then light hydrocarbons can be released from the system and lost along with the un-reacted hydrogen. Therefore, according to a specific embodiment of the invention, to reduce the loss of light hydrocarbons, the pressure inside the first-stage effluent stabilizer (103) is maintained between about 8 bar g to about 15 bar g. According to another specific embodiment of the present invention, the pressure inside the first-stage effluent stabilizer (103) is maintained between about 10 bar g to about 13 bar g.

Additionally, in order to reduce light hydrocarbon loss, the temperature of the first-stage effluent stabilizer (103) overhead reflux drum (not shown) is maintained between about 10° C. to about 55° C. Preferably, the temperature of the first-stage effluent stabilizer (103) overhead reflux drum is maintained between about 10° C. to about 35° C. The temperature of the first-stage effluent stabilizer (103) can be maintained through various means as known in the art, for example, by a cooling water, air cooled or by a refrigerated overhead condenser or feed temperature control. In a specific embodiment of the invention, the temperature of the first-stage effluent stabilizer (103) is maintained by a feed heater (not shown). In another specific embodiment of the invention, the temperature of the first-stage effluent stabilizer (103) is maintained by a cooling water condenser (not shown).

The partially hydrogenated condensed hydrocarbon stream, comprising light and heavier hydrocarbons, exits the first-stage effluent stabilizer (103) through the bottom (202) while un-reacted hydrogen vapor and a relatively small amount of uncondensed hydrocarbons, i.e., off gases (201), exit through the top of the first-stage effluent stabilizer overhead drum (not shown). The partially hydrogenated condensed hydrocarbons, including both light and heavy hydrocarbons from first-stage effluent stabilizer (202) are further processed. The un-reacted hydrogen and uncondensed hydrocarbons, which exit through the top of the first-stage effluent stabilizer (103) overhead drum, leave the system as off gases (201). These gases are typically lost to the fuel gas system.

The partially hydrogenated condensed hydrocarbon stream (202) that exits from the bottom of the first-stage effluent stabilizer (103) comprises mainly C₄ through C₆ paraffins and olefins and non-styrenic aromatics, along with other light and heavy hydrocarbons. This hydrocarbon stream can then be sent to a tailing tower (105) to remove heavy hydrocarbons (e.g., C₉+ hydrocarbons).

The partially hydrogenated hydrocarbon stream from the tailing tower (105) overhead is sent through a second-stage reactor feed pump (not shown) to significantly increase the pressure of the stream prior to entering the second-stage hydrogenation reactor (107), to a pressure ranging from about 32 bar g to about 38 bar g, preferably from about 35 bag g to about 36 bar g. This hydrocarbon stream can also optionally be sent through a second stage hydrogenation preheat drum (not shown) and a second stage hydrogenation charge heater (not shown) where the stream temperature can be increased significantly to a temperature ranging from about 230° C. to about 320° C. to cause the liquid stream to become a vapor stream (not shown in the FIGURE).

The hydrocarbon stream is then sent to a second-stage hydrogenation reactor (107) where the unsaturated hydrocarbons are further processed. The second-stage hydrogenation reactor (107) utilizes a catalyst that can be either nickel, palladium, cobalt, molybdenum or chrome based catalyst or mix of these metals. Catalyst volume is a function of feed rate and olefins concentration and desires catalyst cycle life time. Similar to the first-stage hydrogenation reactor, the specific reaction conditions (e.g., temperature, pressure, volume, etc.) in the second-stage hydrogenation reactor will vary depending on the type of catalyst used. The specific reaction conditions for each catalyst are known in the art. In the second-stage hydrogenation reactor (107) the focus is the hydrogenation of olefins into saturated hydrocarbons without hydrogenation of aromatic compounds by utilizing conditions known in the art. The catalyst and the reactor conditions in the second-stage hydrogenation reactor set a more severe level of hydrogenation in comparison with the first stage reactor. The catalyst type and reactor conditions will direct the hydrogenation of olefins and sulfur species. Mercaptans (i.e., impurities) are also hydrogenated to hydrogen sulfide in the second-stage hydrogenation reactor (107).

The second-stage hydrogenation reactor (107) effluent comprises C₄ to C₈ paraffins and aromatics like benzene, toluene and xylenes. The hydrocarbons in the effluent are fully hydrogenated, which means that the overall conversion of the unsaturated to the saturated components are better than 95% hydrogenated. The hydrogenated hydrocarbon stream is partially condensed in a condenser on the second-stage stabilizer. This condenser partially condenses the reactor effluent and this condensing step separates the unreacted hydrogen from the hydrogenated product. This can be achieved by cooling the second-stage effluent to condense it in order to remove hydrogen, which is not condensed. The condensed effluent can then be heated to reduce condenser loads of the subsequent tower of the second-stage stabilizer. The condensed hydrocarbon stream is heated and fed to the second-stage effluent stabilizer (108).

Maintaining an appropriate pressure and temperature within the second-stage effluent stabilizer (108) minimizes loss of C₄ hydrocarbons from the second-stage effluent stabilizer reflux drum (not shown). Typically, if the pressure within the second-stage effluent stabilizer (108) is too high, then additional energy is required to separate the C₄ hydrocarbons from the un-reacted hydrogen. Alternatively, if the pressure in the second-stage effluent stabilizer (108) is too low then C₄ hydrocarbons will be lost to the fuel gas system along with the un-reacted hydrogen (204). Therefore, according to an embodiment of the invention, to substantially reduce the loss of C₄ hydrocarbons, the pressure inside the second-stage effluent stabilizer (108) is maintained between about 10 bar g to about 20 bar g. According to a specific embodiment, the pressure inside the second-stage effluent stabilizer (108) is maintained between about 14 bar g to about 18 bar g.

Additionally, in order to reduce energy consumption, the temperature of the second-stage effluent stabilizer (108) overhead reflux drum is maintained between about 10° C. to about 55° C. Preferably, the temperature of the second-stage effluent stabilizer (108) overhead reflux drum is maintained between about 10° C. to about 35° C. This temperature range allows the use of cooling water for condensing the second-stage effluent stabilizer overhead in the overhead reflux drum. In a specific embodiment of the invention, the temperature of the second-stage effluent stabilizer (108) is maintained by a cooling water condenser (not shown). In another specific embodiment, the temperature of the second-stage effluent stabilizer (108) is maintained by air cooling or refrigeration.

The hydrogenated liquid hydrocarbon stream from the bottom of the second-stage effluent stabilizer (108) is comprised mainly of C₄ to C₈ paraffins and aromatics like benzene, toluene and xylenes. The uncondensed hydrocarbons and un-reacted hydrogen vapor (off gases) (204) exit through the top of the second-stage effluent stabilizer reflux drum.

The hydrogenated liquid hydrocarbon stream (205) is sent to a finishing tower (110). The Finishing Tower is design finish/separate the second-stage hydrogenated product into to streams two streams: a saturated C₄-C₆ stream and a stream containing hydrogenated gasoline and C₆-C₈ hydrocarbons. In the finishing tower (110), the saturated C₄ to C₅ light hydrocarbons (111) can be separated from the C₆ to C₈ heavy hydrocarbons (112) which exit the finishing tower (110). After leaving the finishing tower (110), the hydrogenated light hydrocarbons and hydrogenated heavy hydrocarbons can be sent to other downstream processing units (not shown) for further conversion or purification to fungible products.

The description has not attempted to exhaustively enumerate all possible variations. The alternate embodiments may not have been presented for a specific portion of the disclosure, and may result form a different combination of described portions, or that other undescribed alternate embodiments may be available for a portion, is not to be considered a disclaimer of those alternate embodiments. Furthermore, it is appreciated that additional equipment or components that have not been explicitly stated or described that are traditionally used in hydrogenation systems (e.g., motors, drives, pumps, blowers, compressors, agitators, tanks, towers, drums, heaters, dryers, towers, jackets, filters, vents, valves, mixers, hoses, tubes, pipes, etc.) can be used in conjunction with the invention and are considered part of the invention. It will be appreciated that many of those undescribed embodiments are within the literal scope of the following claims, and others are equivalent.

The aforementioned hydrogenation system and method provide efficient and simultaneous co-hydrogenation of light hydrocarbons and heavy hydrocarbons. The invention provides a system and method for simultaneous co-hydrogenation of light hydrocarbons and heavy hydrocarbons in addition to providing conditions for post-reactor stabilizers to reduce or minimize light hydrocarbon losses. In this manner, light hydrocarbons that are traditionally lost with un-reacted hydrogen as off-gases, which can then only be burned as an energy source, are preserved. The system and method for reducing light hydrocarbon losses can be combined with the system and method for simultaneously hydrogenating light and heavy hydrocarbons as described above. Alternatively, the presently described system and method for reducing light hydrocarbon losses herein may be used in traditional processes where the light and heavy hydrocarbons are separated prior to hydrogenation. According to a specific embodiment of the present invention, the instantly claimed process would provide a feed directly from a thermal or catalytic cracking conversion unit that included a stream of unsaturated C₄₊ compounds.

The invention provides a pressure and temperature profile for the post-reactor stabilizers, which allows the design to vent un-reacted hydrogen from the hydrogenation reactors (e.g., 201 and 204), while condensing light hydrocarbons, primarily C₄ hydrocarbons (e.g., 202 and 205). These condensed light hydrocarbons can then further processed or used/sold as fungible products.

The present invention can be illustrated by the following prophetic example. This example is intended for illustrative purposes only and should not be considered as limiting the invention. FIG. 1 illustrates, in flowchart form, an embodiment of the disclosed system. Heavy (e.g., gasoline) and light (e.g., mixed C₄) hydrocarbons (101) are combined and co-hydrogenated in a first-stage hydrogenation reactor (102). After hydrogenation, the partially hydrogenated hydrocarbons are sent to a first-stage effluent stabilizer to condense the hydrocarbons (103). The temperature and pressure in the first-stage effluent stabilizer is maintained between about 10° C. to about 35° C. and about 8 bar g to about 15 bar g, respectively, in order to minimize the light hydrocarbon loss in the off-gas (201). The condensed partially hydrogenated hydrocarbons are then sent to a first tailing tower (105) where heavy (e.g., C₈+) hydrocarbons are removed from the stream (106).

The lighter hydrocarbons that exit the bottom of the tailing tower are further hydrogenated in a second-stage hydrogenation reactor (107). The hydrocarbons are then sent to a second-stage effluent stabilizer to condense the hydrocarbons (108). The temperature and pressure in the second-stage effluent stabilizer is maintained between about 10° C. to about 35° C. and about 10 bar g to about 20 bar g, respectively, in order to minimize the light hydrocarbon loss in the off-gas (204). After exiting the second-stage effluent stabilizer, the hydrogenated condensed hydrocarbons are sent to a finishing tower (110). In the finishing tower, the hydrogenated light hydrocarbons (e.g., C₄ hydrocarbons) (111) and the hydrogenated heavy hydrocarbons (e.g., gasoline, C₆+) (112) are separated

Table 1 and Table 2 below provide theoretical stream characteristics during various stages of the system shown in FIG. 1.

TABLE 1
Composition of stream entering and exiting first-stage effluent stabilizer.

| | | Stream | Vapor | Effluent |
|---|---|---|---|---|
| | | Entering 1st | Exiting | Exiting 1st |
| | | Stabilizer | 1st Stabilizer | Stabilizer |
| Composition | | (200) | (201) | (202) |
| Phase (V, L, S) | | V-L | V | L |
| Component | wt % | | | |
| H2 | | 0.05 | 0.29 | 0.00 |
| C₃ and Lighter | | 0.37 | 1.87 | 0.09 |
| C₄ Diolefins | | 0.00 | 0.00 | 0.00 |
| C₄ Olefins | | 2.74 | 7.77 | 1.81 |
| C₄ Paraffins | | 8.85 | 23.66 | 6.10 |
| C₅ Diolefins | | 0.00 | 0.00 | 0.00 |
| C₅ Olefins | | 1.22 | 1.90 | 1.09 |
| C₅ Paraffins | | 7.32 | 11.46 | 6.55 |
| C₆ Olefins | | 1.13 | 0.88 | 1.18 |
| C₆ Paraffins | | 21.77 | 19.77 | 22.15 |
| C₇'s | | 17.75 | 9.36 | 19.31 |
| Benzene | | 22.26 | 15.85 | 23.46 |
| Toluene | | 7.75 | 2.92 | 8.65 |
| Styrene | | 0.04 | 0.01 | 0.05 |
| EB & Xylenes | | 2.09 | 0.44 | 2.39 |
| CUMENE | | 1.03 | 0.16 | 1.19 |
| (isopropylbenzene) | | | | |
| Naphthenes | | 4.01 | 2.73 | 4.25 |
| Cy-Alkenes | | 0.74 | 0.83 | 0.73 |
| C₈ and Heavier | | 0.87 | 0.12 | 1.01 |
| Sulfur Components | | 0.01 | 0.00 | 0.01 |
| Total Flow | kg/hr | 360265 | 56499 | 303766 |
| Mol. Wt. | | 79.63 | 65.09 | 83.08 |
| Temperature | ° C. | 142.70 | 147.50 | 165.00 |
| Pressure | bar g | 12.01 | 11.94 | 12.01 |
| Density @ T.P | kg/m³ | 256.68 | 28.84 | 556.63 |
| Viscosity @ T.P | cP | 0.13 | 0.01 | 0.12 |
| Surface Tension | dyne/cm | 8.10 | | 6.68 |

TABLE 2
Composition of stream entering and exiting second stage stabilizer.

| | | Stream | Vapor | Effluent |
|---|---|---|---|---|
| | | Entering 2st | Exiting | Exiting 2st |
| | | Stabilizer | 2st Stabilizer | Stabilizer |
| Composition | | (203) | (204) | (205) |
| Phase (V, L, S) | | V-L | V | V-L |
| Component | wt % | | | |
| H₂ | | 0.05 | 0.66 | 0.00 |
| C₃ and Lighter | | 0.58 | 12.18 | 0.34 |
| C₄ Diolefins | | 0.00 | 0.00 | 0.00 |
| C₄ Olefins | | 0.01 | 0.11 | 0.01 |
| C₄ Paraffins | | 13.31 | 80.75 | 11.76 |
| C₅ Diolefins | | 0.00 | 0.00 | 0.00 |
| C₅ Olefins | | 0.02 | 0.01 | 0.02 |
| C₅ Paraffins | | 8.64 | 4.85 | 8.71 |
| C₆ Olefins | | 0.02 | 0.00 | 0.02 |
| C₆ Paraffins | | 23.21 | 0.68 | 23.45 |
| C₇'s | | 18.01 | 0.03 | 18.19 |
| Benzene | | 22.46 | 0.30 | 22.69 |
| Toluene | | 7.83 | 0.00 | 7.91 |
| Styrene | | 0.00 | 0.00 | 0.00 |
| EB & Xylenes | | 1.46 | 0.00 | 1.47 |
| CUMENE | | 0.06 | 0.00 | 0.08 |
| (isopropylbenzene) | | | | |
| Naphthenes | | 4.99 | 0.15 | 5.04 |
| Cy-Alkenes | | 0.01 | 0.00 | 0.01 |
| C₈ and Heavier | | 0.30 | 0.00 | 0.30 |
| Sulfur Components | | 0.01 | 0.28 | 0.00 |
| Total Flow | kg/hr | 354768 | 32181 | 351200 |
| Mol. Wt. | | 78.65 | 47.92 | 80.72 |
| Temperature | ° C. | 149.90 | 90.90 | 116.20 |
| Pressure | bar g | 16.73 | 16.69 | 3.22 |
| Density @ T.P | kg/m³ | 355.12 | 34.96 | 19.81 |
| Viscosity @ T.P | cP | 0.11 | 0.01 | 0.18 |
| Surface Tension | dyne/cm | 7.16 | | 12.11 |

Commercial applicability of the disclosed light hydrocarbon and heavy hydrocarbon co-hydrogenation technology provides a unique method for upgrading two non-fungible products (1) raw light hydrocarbons and (2) raw heavy hydrocarbons. This co-hydrogenation will save capital cost and energy for the end-users.

What is claimed is:

1. A method for co-hydrogenating C₄ hydrocarbons and C₅₊ hydrocarbons, said method comprising:
(a) obtaining a combined hydrocarbon stream comprising C₄ and C₅₊ hydrocarbons, wherein the ratio of C₄ and C₅₊ hydrocarbons ranges from about 1:20 to about 20:1;
(b) partially hydrogenating diolefinic and olefinic components in the combined hydrocarbon stream in a first-stage hydrogenation reactor to produce a partially hydrogenated hydrocarbon stream;
(c) condensing the partially hydrogenated hydrocarbon stream in a first-stage effluent stabilizer to produce a condensed partially hydrogenated hydrocarbon stream and an off-gas stream;
(d) hydrogenating primarily olefins and sulfur species in a second stage hydrogenation reactor to produce a fully hydrogenated C₄+ stream;
(e) condensing the fully hydrogenated hydrocarbon stream in second-stage effluent stabilizer to produce a condensed fully hydrogenated hydrocarbon stream and a second off-gas stream; and
(f) directing said condensed fully hydrogenated hydrocarbon stream to a finishing tower, to separate hydrogenated light hydrocarbons from hydrogenated heavy hydrocarbon products.

2. The method of claim 1, wherein the condensed partially hydrogenated hydrocarbon stream of step (c) is directed to a tailing tower to separate relatively heavy hydrocarbons from relatively lighter partially hydrogenated hydrocarbons prior to step (d).

3. The method of claim 1, wherein the pressure within the first-stage effluent stabilizer is from about 8 barg to about 15 barg and the pressure within the second-stage effluent stabilizer is from about 10 barg to about 20 barg.

4. The method of claim 3, wherein the pressure within the first-stage effluent stabilizer is from about 10 barg to about 13 barg and the pressure within the second-stage effluent stabilizer is from about 14 barg to about 18 barg.

5. The method of claim 1, wherein the temperature within the first-stage effluent stabilizer and the second-stage effluent stabilizer is from about 10° C. to about 35° C.

6. The method of claim 5, wherein the temperature of the first-stage effluent stabilizer and the second-stage effluent stabilizer is maintained using cooling water.

7. The method of claim 5, wherein the temperature of the first-stage effluent stabilizer and the second-stage effluent stabilizer is maintained using cooling air.

8. The method of claim 1, wherein a portion of said condensed partially hydrogenated hydrocarbon stream is recycled to said first hydrogenation reactor.

9. The method of claim 1, wherein a portion of effluent from said second hydrogenation reactor is condensed before entry into the second stage effluent stabilizer and recycled to said second hydrogenation reactor.

10. The method of claim 1, wherein said feed to the first hydrogenation reactor comprises two separate feed streams, a first feed stream comprising mostly mixed C₄ hydrocarbons and the second feed stream comprising gasoline.

11. The method of claim 1, where two separate feed streams one comprising mostly C₄ hydrocarbons and a second comprising mostly C₅ and heavier hydrocarbons are mixed in a mixing drum upstream of said first hydrogenation reactor.

12. The method of claim 1, wherein a portion of said hydrogenated hydrocarbon stream from step (f) is recycled to said second hydrogenation reactor.

13. The method of claim 1, wherein the ratio of lighter hydrocarbon to heavier hydrocarbons ranges from about 1:10 to about 10:1.

14. The method of claim 13, wherein said ratio ranges from about 1:5 to about 5:1.

15. A system for hydrogenation of a mixture of C₄₊ hydrocarbons comprising, sequentially connected, a first-stage hydrogenation reactor, a first-stage effluent stabilizer, a tailing tower, a second stage hydrogenation reactor, a second-stage effluent stabilizer and a finishing tower, wherein diolefinic and olefinic components C₄ hydrocarbons are simultaneous hydrogenated along with diolefinic and olefinic components C₅₊ hydrocarbons within the first-stage hydrogenation reactor and the second-stage hydrogenation reactor and wherein the ratio of C₄ hydrocarbons to C₅₊ hydrocarbons ranges from about 1:20 to about 20:1.

16. The system of claim 15, wherein the pressure within the first-stage effluent stabilizer is from about 8 barg to about 15 barg and the pressure within the second-stage effluent stabilizer is from about 10 barg to about 20 barg.

17. The system of claim 15, wherein the pressure within the first-stage effluent stabilizer is from about 10 barg to about 13 barg and the pressure within the second-stage effluent stabilizer is about 14 barg to about 18 barg.

18. The system of claim 15, wherein the temperature within the second-stage effluent stabilizer is from about 10° C. to about 35° C.

19. The system of claim 18, wherein the temperature of the first-stage effluent stabilizer and the second-stage effluent stabilizer is maintained using cooling water or cooling air.

20. The system of claim 15, wherein the ratio of C₄ hydrocarbons to C₅₊ hydrocarbons ranges from about 1:10 to about 10:1.
